(19) United States
(12) Patent Application Publication
(10) Pub. No.: US 2010/0125761 A1
(43) Pub. Date: May 20, 2010

(54) SYSTEM AND METHOD FOR WAFER-LEVEL ADJUSTMENT OF INTEGRATED CIRCUIT CHIPS

(75) Inventors: Seok Bong HYUN, Daejeon (KR); Hee Tae LEE, Daejeon (KR); Kyung Hwan PARK, Daejeon (KR); Sung Weon KANG, Daejeon (KR); Heyung Sub LEE, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/465,579

(22) Filed: May 13, 2009

(30) Foreign Application Priority Data
Nov. 14, 2008 (KR) 10-2008-0113434

(51) Int. Cl. G06F 11/00

(52) U.S. Cl. 714/47

(57) ABSTRACT

A system and method for wafer level adjusting of IC chips are disclosed. The system and method for a wafer level adjustment of IC chips connect the analog circuits of the IC chip with the adjustment controller outside the semiconductor wafer via the probing region and the signal transmission region outside the IC chip, measure and adjust the performance of the IC chip by the adjustment controller, and then, only store final adjustment data in the adjustment memory of the IC chip. Accordingly, it is possible to reduce the area of adjustment circuits added to an integrated circuit chip such as an RFID tag chip and adjust the performance of chips at a wafer level.

### CROSS-REFERENCE TO RELATED APPLICATIONS

This application claims the priority of Korean Patent Application No. 2008-0113434 filed on Nov. 14, 2008, in the Korean Intellectual Property Office, the disclosure of which is incorporated herein by reference.

### BACKGROUND OF THE INVENTION

1. Field of the Invention

The present application relates to a system and method for wafer-level adjustment (i.e., tuning) of integrated circuit chips capable of uniformly adjusting the performance of integrated circuit (IC) chips at the wafer level, and more particularly, to a system and method for the wafer-level adjustment of integrated circuit chips capable of adjusting the performance of IC chips for radio frequency identification (RFID) or a ubiquitous sensor network (USN) such that it is suitable for operations within a pre-set specifications.

2. Description of the Related Art

In general, RFID, a technology that utilizes radio frequency to read information from, or embed information within, a tag is used to identify, track and manage a product, animal, or person to which a tag has been attached or applied. In order to apply RFID tags to large numbers of objects, an extremely low-cost mass-production technique for RFID tag chips, as low as 1 cent per unit, is required.

In order to mass-produce semiconductor chips such as RFID or USN tag chips at extremely low prices, a method for minimizing the size of individual chips and their power consumption as well as for the uniform adjustment of the performance of chips at the wafer level is required.

In general, the performance of RF/analog chips fabricated via a semiconductor process is not completely uniform, due to the influence of process variations, therefore the characteristic values of transistors, resistors, capacitors, and the like (the basic elements of the chips) may vary by more than 10% depending on the chip wafers.

A chip having only a digital logic circuit is less affected by such process variation, while an analog circuit such as a clock generating oscillator using a capacitor element, or a bias circuit using a resistor element, is much more affected by the process variations.

Thus, in the related art, in order to calibrate the influence of the process variations, a laser trimming method is performed, or a calibration circuit is additionally integrated in chips.

However, such adjustment methods require lengthy periods of time or additional chip area to be implemented, thus, they are unsuitable for RFID/USN tag chip production methods aiming for extremely low production costs.

Meanwhile, even if chips are tested after they are completely sawed and packed, defective chips may still be packaged, incurring an unnecessary additional cost, so it would be preferable to finish testing and adjusting chips while they remained on the wafer, if possible.

However, in the related art, only a testing system for determining whether or not the wafer level tag chips are defective has been developed, while a system for adjusting the performance of tag chips at the wafer level has not yet been developed.

### SUMMARY OF THE INVENTION

An aspect of the present application provides a system and method for wafer-level adjustment of integrated circuit (IC) chips capable of reducing the area of adjustment circuits added to an integrated circuit chip such as an RFID tag chip and adjusting the performance of chips at a wafer level.

According to an aspect of the present invention, there is provided a system for the wafer-level adjustment of IC chips, including: a semiconductor wafer having a plurality of IC chips for adjusting chip performance according to an adjustment value received from the outside of the wafer in the case of chip performance adjustment and for storing the adjustment value and adjusting chip performance according to the stored adjustment value in the case of the completion of the chip performance adjustment, a probing region including a plurality of probing pads disposed therein, and a signal transmission region including a plurality of signal lines electrically connecting the probing pads of the probing region and the plurality of IC chips; and an adjustment controller located outside the semiconductor wafer and electrically connected to at least one of the IC chips via the probing region, measuring and adjusting the performance of the IC chips while varying the adjustment value provided to the IC chips in the case of the chip performance adjustment, and providing the adjustment value to be stored in the IC chips in the case of the completion of the chip performance adjustment.

Each of the IC chips may include: an adjustment memory for storing the adjustment value provided from the adjustment controller in the case of the completion of the chip performance adjustment; and a multiplexer for selectively outputting the adjustment value directly provided from the adjustment controller in the case of the chip performance adjustment, and for selectively outputting the adjustment value stored in the adjustment memory in the case of the completion of the chip performance adjustment.

The adjustment memory may be a one-time programmable memory.

Each of the IC chips may further include: a serial-to-parallel data converter for converting the adjustment value transmitted in the form of serial data from the adjustment controller into a parallel data form; and at least one buffer for buffering the output signals of the chip core circuit and the adjustment value.

The chip core core circuit may include: a signal matching unit for varying a mean frequency (center frequency) of an antenna according to an output signal from the multiplexer and transmitting/receiving a signal via the antenna; a signal converting unit for modulating and demodulating a signal transmitted/received via the signal matching unit; a voltage multiplying unit for converting a signal received via the signal matching unit into DC power; a power management unit for varying the voltage values of bias voltages and an operation voltage required for the chip core circuit according to an output signal from the multiplexer; a clock generating unit for varying the frequency of a clock according to an output signal from the multiplexer; a digital controller for performing a sensing operation on the IC chips; and a nonvolatile memory for storing data required for the operation of the digital controller and data generated according to the operation of the digital controller.

The signal transmission region may be formed at a scribe region to be removed in a chip cutting step, and may further have at least one buffer for buffering the output signals of the chip core circuit disposed on the signal lines and the adjustment values thereof.

According to another aspect of the present invention, there is provided a semiconductor wafer including: a plurality of IC chips; a probing region including a plurality of probing pads disposed to be in contact with the probing pins of an adjustment controller; and a signal transmission region including a plurality of signal lines electrically connecting the probing pads and the IC chips, wherein each of the IC chips includes: an adjustment memory for storing an adjustment value provided from the adjustment controller in the case of the completion of the chip performance adjustment, a multiplexer for outputting the adjustment value directly provided from the adjustment controller in the case of the chip performance adjustment and for outputting the adjustment value stored in the adjustment memory in the case of the completion of the chip performance adjustment core circuit

core circuit The adjustment memory may be a one-time programmable memory.

Each of the IC chips may further include: a serial-to-parallel data converter for converting the adjustment value transmitted in the form of serial data from the adjustment controller into a parallel data form; and at least one buffer for buffering the output signals of the chip core circuit and the adjustment value.

The chip core circuit may include: a signal matching unit for varying a mean frequency (center frequency) of an antenna according to an output signal from the multiplexer and transmitting/receiving a signal via the antenna; a signal converting unit for modulating and demodulating a signal transmitted/received via the signal matching unit; a voltage multiplying unit for converting a signal received via the signal matching unit into DC power; a power management unit for varying voltage values of bias voltages and an operation voltage required for the chip core circuit according to an output signal from the multiplexer; a clock generating unit for varying the frequency of a clock according to an output signal from the multiplexer; a digital controller for performing a sensing operation on the IC chips; and a nonvolatile memory for storing data required for the operation of the digital controller and data generated according to the operation of the digital controller.

The signal transmission region may be formed at a scribe region removed in a chip cutting step, and may further have at least one buffer for buffering the output signals of the chip core circuit disposed on the signal lines and the adjustment value.

According to yet another aspect of the present invention, there is provided a method for the adjustment of integrated circuit (IC) chips of a system for the wafer-level adjustment of IC chips including: a semiconductor wafer including a plurality of IC chips, a probing region including a plurality of probing pads disposed therein, and a signal transmission region including a plurality of signal lines electrically connecting the probing pads of the probing region and the plurality of IC chips, and an adjustment controller positioned outside the semiconductor wafer, the method including: electrically connecting the adjustment controller to the IC chips via the probing region and the signal transmission region; determining whether or not the performance of the IC chips satisfies pre-set specifications while variably providing, by the adjustment controller, an adjustment value for adjusting the performance of the IC chips; storing, by the adjustment controller, the adjustment value when the performance of the IC chips satisfies the pre-set specifications, in the IC chips; and completing, by the IC chips, the performance adjustment according to the stored adjustment value.

The determination of whether or not the performance of the IC chips satisfies the pre-set specifications may include: calculating, by the adjustment controller, the adjustment value for adjusting the performance of the IC chips and providing the calculated adjustment value to the IC chips; adjusting, by the IC chips, the performance of the IC chips according to the adjustment value, and outputting an adjustment result value to the adjustment controller; and if the adjustment result value does not satisfy the specifications, varying, by the adjustment controller, the adjustment value and providing a varied adjustment value to the IC chips.

In storing the adjustment value in the IC chips, the adjustment value may be stored in a one-time programmable memory provided in the IC chips.

The performance of the IC chips may be determined by at least one of a reference bias voltage, a clock frequency and a mean frequency of an antenna.

### BRIEF DESCRIPTION OF THE DRAWINGS

The above and other aspects, features and other advantages of the present application will be more clearly understood from the following detailed description taken in conjunction with the accompanying drawings, in which:

FIG. 1 is a schematic block diagram of a system for wafer-level adjustments of integrated circuit (IC) chips;

FIG. 2 is a detailed view of a semiconductor wafer according to an exemplary embodiment of the present invention; and

FIG. 3 is a flow chart illustrating a method for the adjustment of IC chips according to an exemplary embodiment of the present invention.

### DETAILED DESCRIPTION OF THE PREFERRED EMBODIMENT

Exemplary embodiments of the present application will now be described in detail with reference to the accompanying drawings. The invention may however be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

In addition, unless explicitly described to the contrary, the word “comprise” and variations such as “comprises” or “comprising,” will be understood to imply the inclusion of stated elements but not the exclusion of any other elements.

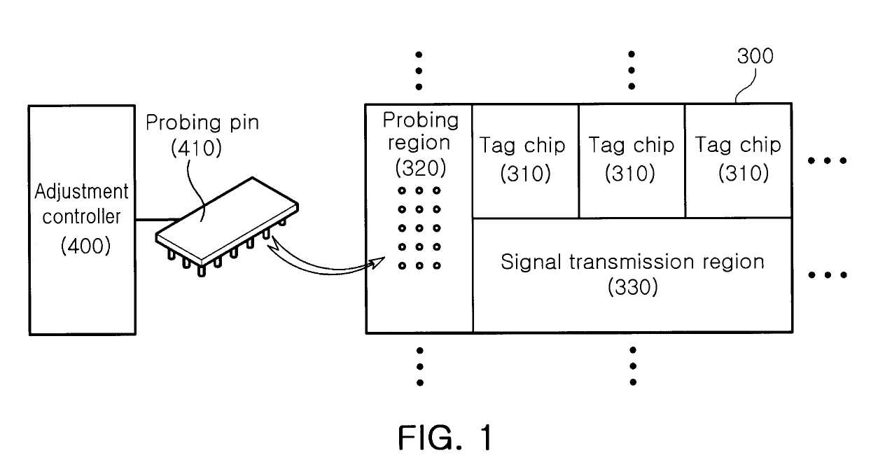

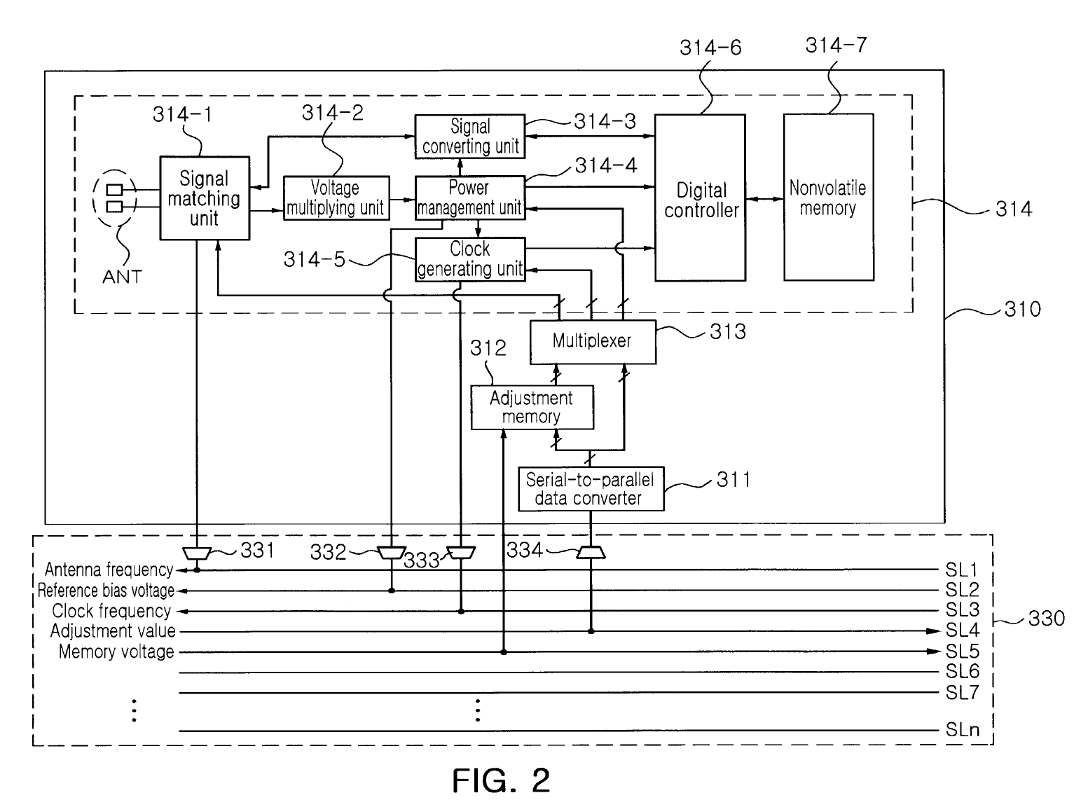

FIG. 1 is a schematic block diagram of a system for wafer-level adjustments of integrated circuit (IC) chips, and FIG. 2 is a detailed view of a semiconductor wafer according to an exemplary embodiment of the present invention.

A tag chip will be described as an example of an IC chip for the sake of brevity.

With reference to FIG. 1, a system for the wafer-level adjustment of IC chips includes a semiconductor wafer 300 and an adjustment controller 400 positioned outside the semiconductor wafer 300 and testing and adjusting the performance of a tag chip 310 within the semiconductor wafer 300. The semiconductor wafer 300 includes a plurality of tag chips 310, a probing region 320, and a signal transmission region 330.

As shown in FIG. 2, the tag chip 310 includes a serial-to-parallel data converter 311 that converts an adjustment value transmitted in the form of serial data from the adjustment controller 400 into a parallel data form, an adjustment memory 312 that stores the adjustment value provided from the adjustment controller 400 under the control of the adjustment controller 400, a multiplexer 313 that selectively outputs the adjustment value directly provided from the adjustment controller 400 when chip performance is adjusted, and selectively outputs the adjustment value stored in the adjustment memory 312 when the adjustment of the chip performance is completed, under the control of the adjustment controller 400, and a chip core circuit 314 that adjusts chip performance by adjusting the operational characteristics (e.g., a reference bias voltage, a clock frequency, etc.) of analog circuits within the tag chip 310 according to an output value from the multiplexer 313, and performing a sensing operation according to the adjusted chip performance.

The adjustment memory 312 may be implemented as a one-time programmable (OTP) memory that stores data in an anti-fuse or fuse manner. This is to store the adjustment value provided from the adjustment controller 400 in the minimum possible area for the minimum possible cost.

The chip core circuit 314 includes a signal matching unit 314-1 that performs an impedance matching operation and an antenna frequency setting operation to transmit and receive a signal via an antenna ANT, a voltage multiplying unit 314-2 that rectifies a weak (feeble) RF signal received via the signal matching unit 314-1 so as to convert it into DC power, a signal converting unit 314-3 that modulates and demodulates a signal transmitted and received between a digital controller 314-6 and the signal matching unit 314-1, a power management unit 314-4 that varies a reference bias voltage according to an output value of the multiplexer 313 and generates various bias voltages and an operation voltage required for the chip core circuit 314 on the basis of the varied reference bias voltage, a clock generating unit 314-5 that varies a clock frequency according to an output value of the multiplexer 313, a digital controller 314-6 that performs a sensing operation on the tag chip 310 according to the chip performance adjusted according to the output value of the multiplexer 313, and a nonvolatile memory 314-7 that stores the data required for the operation of the digital controller 314-6 and data generated according to the operation of the digital controller 314-6.

Besides the function of adjusting the influence of a process variation in response to the output value of the multiplexer 313, the chip core circuit 314 may adjust a mean frequency (center frequency) of the antenna ANT of the signal matching unit 314-1 according to the output value of the multiplexer 313 to match frequency standards which may different in different countries.

The signal matching unit 314-1, the power management unit 314-4, and the clock generating unit 314-5, which adjust their operational characteristics according to the output value of the multiplexer 313, are implemented as analog circuits, and their operational characteristics adjusting operations follow the known art.

For example, as for the signal matching unit 314-1, a capacitor of a resonance circuit may be implemented as a variable capacitor or a capacitor array having a capacitor value varying according to the output value of the multiplexer 313, to adjust the mean frequency of the antenna. As for the power management unit 314-4, a resistor of a reference bias circuit may be implemented as a variable resistor or a resistor array having a resistance value varying according to the output value of the multiplexer 313, to adjust a voltage value of the reference bias. Also, as for the clock generating unit 314-5, a capacitor of an oscillation circuit may be implemented as a variable capacitor or a capacitor array having a capacitor value varying according to the output value of the multiplexer 313, to adjust the mean frequency of a clock.

The probing region 320 corresponds to at least one tag chip 310 and includes a plurality of probing pads (or probing terminals) to which probing pins 410 of the adjustment controller 400 are brought in contact electrically.

The signal transmission region 330 includes a plurality of signal lines SL1 to SLn disposed for electrically connecting the plurality of probing pads disposed on the probing region 320 and the tag chips 310.

The signal transmission region 330 is formed at a scribe region, which may be automatically removed by a cutting device in a chip cutting step, i.e., the final step of the semiconductor process, without affecting actual chip area.

For reference, scores to hundreds of the same type tag chips 310 are disposed in a single reticle of the semiconductor wafer. Thus, the signal lines may increase in number up to scores to hundreds, depending on the number of tag chips 310 to be tested. However, although the signal lines increase in number in such manner, the scribe region generally has a width of scores μm or larger, so it does not much affect the actual chip area.

If the signal lines are lengthened because the distance between the probing region 320 and the tag chips 310, buffers 331 to 334 for buffering signals may be added on the signal lines SL1 to SLn or within the tag chip 310. This is to remove various parasitic effects (noise generation, signal attenuation, etc.) that may possibly be generated as the length of the signal lines increases in the wake of the increase in the distance between the probing region 320 and the tag chip 310.

The adjustment controller 400 includes an adjustment program with a previously defined procedure and specifications for testing and adjusting the performance of the tag chips 310. As the plurality of probing pins 410 are brought into contact with the probing pads disposed in the probing region 320, the adjustment controller 400 is electrically connected to the tag chip 310, the subject of the chip performance adjustment.

When the adjustment of the chip performance is performed, the performance of the tag chips 310 is repeatedly checked in order to ascertain whether or not they satisfy pre-set specifications while changing an adjustment value applied to the tag chips 310. When the chip performance satisfies the specifications through such a repeated process, a chip performance completion process is performed to store an adjustment value acquired through a final adjustment process in the adjustment memory 312.

In the case of the chip performance adjustment, the adjustment controller 400 provides a control signal providing information about the ongoing chip performance adjustment; so that the multiplexer 313 of the tag chip 310 can provide the adjustment value directly transmitted from the adjustment controller 400 to the analog circuits 314-1, 314-4, and 314-5. Meanwhile, when the adjustment of chip performance is completed, the adjustment controller 400 provides a memory voltage for a writing operation of the adjustment memory 312 along with a control signal providing information about the completion of the chip performance adjustment. Accordingly, the adjustment memory 312 is activated to store the adjustment value transmitted from the adjustment controller 400 and the multiplexer 313 provides the adjustment value stored in the adjustment memory 312, instead of the adjustment value directly transmitted from the adjustment controller 400, to the analog circuits 314-1, 314-4, and 314-5.

In this manner, in the system of wafer-level adjustment of IC chips according to the exemplary embodiment of the present invention, the probing region 320 and the signal transmission region 330 are additionally provided in the semiconductor wafer 300 to electrically connect the tag chips 310 of the semiconductor wafer 300 and the adjustment controller 400.

The processes of testing and the adjustment of the performance of the tag chips 310 are all performed in the wafer state through the adjustment controller 400, and only the final adjustment completion value is stored in the tag chips 310.

Therefore, in the system of wafer-level adjustment of IC chips according to the exemplary embodiment of the present invention, only the minimum circuits (i.e., the multiplexer 313 and the adjustment memory 312) are added in the tag chip 310 to minimize the burden of an increase in the area in the IC chips required for the performance measuring and adjusting operation.

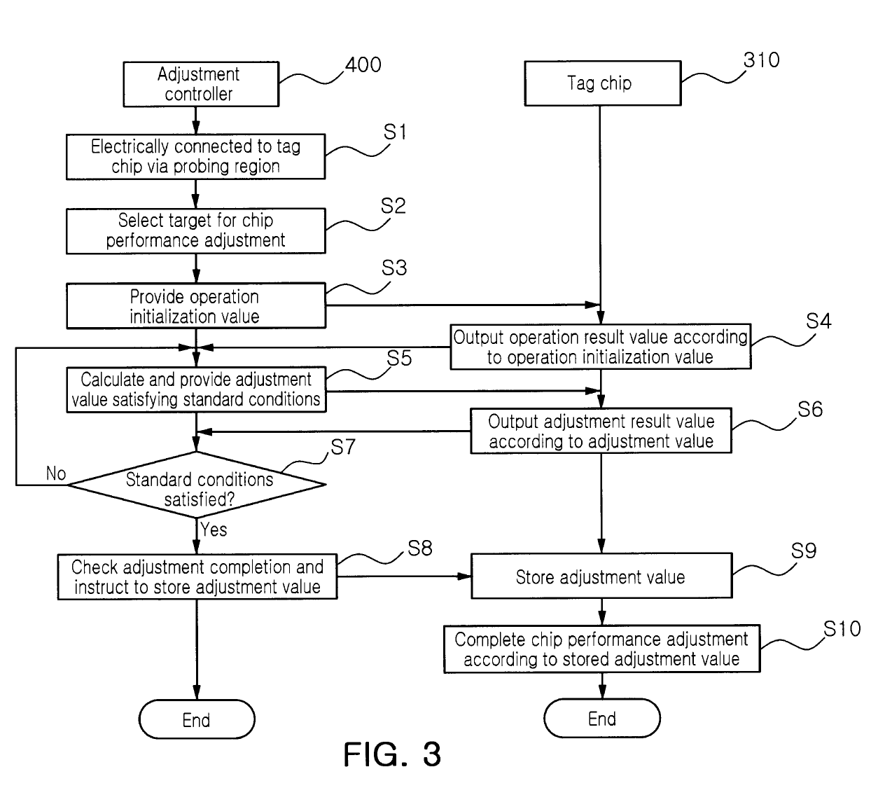

FIG. 3 is a flow chart illustrating a method for the adjustment of IC chips according to an exemplary embodiment of the present invention.

First, the probing pins 410 of the adjustment controller 400 are brought into contact with the probing pads of the probing area 320 to electrically connect the adjustment controller 400 and the tag chips 310, a target of the chip performance adjustment (S1).

The adjustment controller 400 selects the tag chip 310 as the target of the chip performance adjustment (S2), and provides an operation initialization value to the corresponding tag chip 310 (S3). In this case, the operation initialization value is to acquire a reference point of the chip performance adjustment operation.

The corresponding tag chip 310 receives the operation initialization value transmitted via the probing pins 410 and the probing region 320 and the signal transmission region 330 of the semiconductor wafer 300, performs a transmission of test signals, for example, clock outputs, according to the operation initialization value, and provides an operation result to the adjustment controller 400 (S4).

The adjustment controller 400 analyzes the operation result value of the tag chip 310, calculates an adjustment value for making respective operational characteristics of the analog circuits (i.e., the signal matching unit 314-1, the power management unit 314-4, and the clock generating unit 314-5) of the corresponding tag chip 310 satisfy pre-set specifications, and provides the calculated adjustment value to the tag chip 310 (S5).

The tag chip 310 adjusts the operational characteristics of the respective analog circuits according to the adjustment value, and outputs an adjustment result value to the adjustment controller 400 (S6).

Then, the adjustment controller 400 analyzes the adjustment result value, checks whether or not the adjustment result value satisfies the specifications (S7) If the adjustment result value does not satisfy the specifications, the process returns to step S5, and steps S5 to S7 are repeatedly performed until such time as the adjustment result value satisfies the specifications, under the control of the adjustment controller 400.

When the adjustment result value satisfies the specifications through steps S5 to S7 of the chip performance adjustment process, the adjustment controller 400 ascertains that the performance adjustment operation of the tag chip 310 has been successfully performed, and provides a corresponding adjustment value as an adjustment completion value to the tag chip 310 (S8).

The tag chip 310 stores the adjustment value provided from the adjustment controller 400 in its adjustment memory 312 (S9), and completes the chip performance adjustment operation.

The method for adjusting the IC chips illustrated in FIG. 3 may be performed only on a single IC chip or may be simultaneously performed on the plurality of IC chips.

Also, only some IC chips may be sampled from the adjacent IC chips in the semiconductor wafer (or reticle), on which the performance adjustment operation is performed to acquire an adjustment value which is then simultaneously applied to the adjacent IC chips, thereby significantly reducing an adjustment time. This is because the adjacent chips in the same semiconductor wafer are equally affected by a process variation and thus have the same chip performance.

In the exemplary embodiment as described above, the performance of the tag chip 310 is adjusted by adjusting the operational characteristics of the analog circuits provided in the tag chip 310, but the present application is not meant to be limited thereto and may be variably applied to any other cases. For example, if the tag chip 310 includes a sensor, an initial value of the sensor may be adjusted according to the same principle.

As set forth above, the system and method for wafer level adjusting of IC chips according to exemplary embodiments of the invention have the following advantages. That is, after the analog circuits, which are sensitive to process variations, of the IC chip and the adjustment controller outside the semiconductor wafer are directly connected via the probing region and the signal transmission region outside the IC chip, without going through the digital controller of the IC chip, the performance of the IC chip is measured and adjusted by the adjustment controller, and then, only final adjustment data is stored in the adjustment memory of the IC chip.

Thus, measurement and adjustment of the performance of the chip can be simultaneously performed at the wafer level, and only the minimum circuits (i.e., the multiplexer and the one-time programmable memory) are added in the IC chip.

Namely, IC chips having uniform performance can be mass-produced without being affected by process variations, and the cost overheads incurred in the manufacturing of IC chips can be minimized.

Besides the function of calibrating the influence of the process variation, the mean frequency of the antenna can be adjusted to match frequency standards which may differ between countries, or in case of a tag including a sensor, an initial value of the sensor can be adjusted to thereby expand coverage and increase utility.

While the present application has been shown and described in connection with the exemplary embodiments, it will be apparent to those skilled in the art that modifications and variations can be made without departing from the spirit and scope of the invention as defined by the appended claims.

What is claimed is:

1. A system for wafer-level adjustment of integrated circuit (IC) chips, the system comprising:
a semiconductor wafer having a plurality of IC chips for adjusting chip performance according to an adjustment value received from the outside in the case of chip performance adjustment and for storing the adjustment value and adjusting chip performance according to the stored adjustment value in the case of the completion of the chip performance adjustment, a probing region comprising a plurality of probing pads disposed therein, and a signal transmission region comprising a plurality of signal lines electrically connecting the probing pads of the probing region and the plurality of IC chips; and
an adjustment controller located outside the semiconductor wafer and electrically connected to at least one of the IC chips via the probing region, measuring and adjusting the performance of the IC chips while varying the adjustment value provided to the IC chips in the case of the chip performance adjustment, and providing the adjustment value to be stored in the IC chips in the case of the completion of the chip performance adjustment.

2. The system of claim 1, wherein each of the IC chips comprises:
an adjustment memory for storing the adjustment value provided from the adjustment controller in the case of the completion of the chip performance adjustment; and
a multiplexer for selectively outputting the adjustment value directly provided from the adjustment controller in the case of the chip performance adjustment, and for selectively outputting the adjustment value stored in the adjustment memory in the case of the completion of the chip performance adjustment.

3. The system of claim 2, wherein the adjustment memory is a one-time programmable memory.

4. The system of claim 1, wherein each of the IC chips further comprises:
a serial-to-parallel data converter for converting the adjustment value transmitted in the form of serial data from the adjustment controller into a parallel data form.

5. The system of claim 2, wherein each of the IC chips further comprises:
at least one buffer for buffering the output signals of the chip core circuit and the adjustment value.

6. The system of claim 2, wherein each of the IC chips further comprises:
a signal matching unit for varying a mean frequency of an antenna according to an output signal from the multiplexer and transmitting/receiving a signal via the antenna;
a signal converting unit for modulating and demodulating a signal transmitted/received via the signal matching unit;
a voltage multiplying unit for converting a signal received via the signal matching unit into DC power;
a power management unit for varying the voltage values of bias voltages and an operation voltage required for a chip core circuit according to an output signal from the multiplexer;
a clock generating unit for varying the frequency of a clock according to an output signal from the multiplexer;
a digital controller for performing a sensing operation on the IC chips; and
a nonvolatile memory for storing data required for the operation of the digital controller and data generated according to the operation of the digital controller.

7. The system of claim 2, wherein the signal transmission region is formed at a scribe region to be removed in a chip cutting step.

8. The system of claim 2, wherein the signal transmission region further comprises:
at least one buffer for buffering the output signals of a chip core circuit disposed on the signal lines and the adjustment values thereof.

9. A semiconductor wafer comprising:
a plurality of integrated circuit (IC) chips;
a probing region comprising a plurality of probing terminals disposed to be in contact with the probing pins of an adjustment controller; and
a signal transmission region comprising a plurality of signal lines electrically connecting the probing terminals and the IC chips,
wherein each of the IC chips comprises:
an adjustment memory for storing an adjustment value provided from the adjustment controller in the case of the completion of the chip performance adjustment; and
a multiplexer for outputting the adjustment value directly provided from the adjustment controller in the case of the chip performance adjustment and for outputting the adjustment value stored in the adjustment memory in the case of the completion of the chip performance adjustment.

10. The semiconductor wafer of claim 9, wherein the adjustment memory is a one-time programmable memory.

11. The semiconductor wafer of claim 9, wherein each of the IC chips further comprises:
a serial-to-parallel data converter for converting the adjustment value transmitted in the form of serial data from the adjustment controller into a parallel data form.

12. The semiconductor wafer of claim 9, each of the IC chips further comprises:
at least one buffer for buffering the output signals of a chip core circuit and the adjustment value.

13. The semiconductor wafer of claim 9, wherein each of the IC chips further comprises:
a signal matching unit for varying a mean frequency of an antenna according to an output signal from the multiplexer and transmitting/receiving a signal via the antenna;
a signal converting unit for modulating and demodulating a signal transmitted/received via the signal matching unit;
a voltage multiplying unit for converting a signal received via the signal matching unit into DC power;
a power management unit for varying voltage values of bias voltages and an operation voltage required for a chip core circuit according to an output signal from the multiplexer;
a clock generating unit for varying the frequency of a clock according to an output signal from the multiplexer;
a digital controller for performing a sensing operation on the IC chips; and
a nonvolatile memory for storing data required for the operation of the digital controller and data generated according to the operation of the digital controller.

14. The semiconductor wafer of claim 9, wherein the signal transmission region is formed at a scribe region removed in a chip cutting step.

15. The semiconductor wafer of claim 9, wherein the signal transmission region further comprises:
at least one buffer for buffering the output signals of a chip core circuit disposed on the signal lines and the adjustment value.

16. A method for the adjustment of integrated circuit (IC) chips of a system for wafer-level adjustment of IC chips including a semiconductor wafer including a plurality of IC chips, a probing region including a plurality of probing pads disposed therein, and a signal transmission region including a plurality of signal lines electrically connecting the probing terminals of the probing region and the plurality of IC chips, and an adjustment controller positioned outside the semiconductor wafer, the method comprising:
electrically connecting the adjustment controller to the IC chips via the probing region and the signal transmission region;
determining whether or not the performance of the IC chips satisfies pre-set specifications while variably providing, by the adjustment controller, an adjustment value for adjusting the performance of the IC chips;
storing, by the adjustment controller, the adjustment value when the performance of the IC chips satisfies the pre-set specifications, in the IC chips; and
completing, by the IC chips, the performance adjustment according to the stored adjustment value.

17. The method of claim 16, wherein the determination of whether or not the performance of the IC chips satisfies the pre-set specifications comprises:
calculating, by the adjustment controller, the adjustment value for adjusting the performance of the IC chips and providing the calculated adjustment value to the IC chips;
adjusting, by the IC chips, the performance of the IC chips according to the adjustment value, and outputting an adjustment result value to the adjustment controller; and
if the adjustment result value does not satisfy the specifications, varying, by the adjustment controller, the adjustment value and providing a varied adjustment value to the IC chips.

18. The method of claim 16, wherein, in storing the adjustment value in the IC chips, the adjustment value is stored in a one-time programmable memory provided in the IC chips.

19. The method of claim 16, wherein the performance of the IC chips is determined by at least one of a reference bias voltage, a clock frequency and a mean frequency of an antenna.
